(19) United States
(12) Patent Application Publication
(10) Pub. No.: US 2025/0045486 A1
(43) Pub. Date: Feb. 6, 2025

(54) SYSTEMS AND METHODS FOR GENERATING SUPPORT STRUCTURES OF A MECHANIC OBJECT

(71) Applicant: ANSYS, Inc., Canonsburg, PA (US)

(72) Inventor: Martin HUSEK, Weimar (DE)

(21) Appl. No.: 18/587,131

(22) Filed: Feb. 26, 2024

Related U.S. Application Data
(60) Provisional application No. 63/530,362, filed on Aug. 2, 2023.

(30) Foreign Application Priority Data
Dec. 29, 2023 (DE) 10 2023 136 850.8

(51) Int. Cl. G06F 30/23

(52) U.S. Cl. CPC G06F 30/23

(57) ABSTRACT

Methods and apparatuses for generating support structures for a mechanical object are disclosed. One or more load scenarios are obtained to identify a first stress heatmap to represent stress characteristics of a first layer of a mechanical object based on the one or more load scenarios. A mesh of support structures is determined for the object based on the stress heatmap. A design of the mechanical object is updated with the support structures according to the mesh for manufacturing the mechanical object.

### CROSS-REFERENCE TO RELATED APPLICATIONS

This application claims priority to German Patent Application No. 10 2023 136 850.8, filed Dec. 29, 2023, entitled “Method and Device for Generating Support Structures for a Mechanical Object and Object with Support Structures”, which claims the priority of US Provisional Application No. 63,530,362, filed Aug. 2, 2023, entitled “System and Method for Adaptive Stress-Driven Rib Mesh Generation,” both of which are incorporated herein by reference in their entirety.

### TECHNICAL FIELD

This disclosure is related to computer-based methods for generating support structures for mechanical objects. Additionally disclosed are devices for manufacturing mechanical objects with support structures and corresponding support structures.

### BACKGROUND

Support structures, such as ribs, in mechanical objects function as structural reinforcements, crucial for enhancing strength and rigidity while minimizing material use and weight. Support structures are integrated into parts or surfaces that require additional support, especially where bending, buckling, or torsional forces might compromise structural integrity. Commonly found in plastic injection molding and metal casting, ribs are integral in automotive components, aerospace structures, consumer electronics, and various industrial machines. Their design varies based on application needs, ranging from straight linear ribs for flat surfaces to radial and curved ribs. Improvements for these important features are always desirable.

### SUMMARY

An object of the present disclosure is improvement of a mechanical object with support structures.

This object is solved by the disclosed embodiments, which are defined in particular by the subject matter of the independent claims. The dependent claims provide information for further embodiments. Various aspects and embodiments of these aspects are also disclosed in the summary and description below, which provide additional features and advantages.

A first aspect of this disclosure is related to a method for generating support structures for a mechanical object, comprising the steps:
obtaining one or more load scenarios;
identifying a first stress heatmap to represent stress characteristics of a first layer of a mechanical object based on the one or more load scenarios;
determining a mesh of support structures for the object based on the stress heatmap;
updating a design of the mechanical object with the support structures according to the mesh for manufacturing the mechanical object.

A mechanical object can be any material object which can be manufactured or in any other way generated. Mechanical objects can be rigid objects, such as a beam. Mechanical objects can also be flexible objects, such as a rubber mattress. A mechanical object can be a housing for a tool and/or a machine. A mechanical object can be a device or machine, that utilizes mechanical principles to perform a specific function. Other examples of mechanical objects include covers, shelves, frames, household devices, car parts, medical devices, cans of batteries, cooling devices for processors, etc.

A load scenario for a mechanical object can refer to different types of loads the mechanical object may experience. These different types of loads can comprise the various forces, stresses and/or strains that the mechanical object will or may endure during its usage. Load scenarios involve understanding the types of loads an object will face, including static loads like gravity, dynamic loads such as vibrations or impacts, and thermal loads resulting from temperature changes. It also entails assessing the magnitude and distribution of these loads, evaluating how intense these forces are and how they apply across the object. The duration and frequency of one or more loads can also be comprised in a load scenario. Additionally, fatigue and failure analysis may be comprised by a load scenario. A load scenario can comprise the mechanical object to be analyzed and other object, e.g. objects in which the mechanical object to be analyzed is arranged.

An obtaining of an information (e.g. a load scenario) in the sense of this disclosure can comprise a receiving and/or a fetching of this information. Additionally or alternatively, an obtaining can comprise determining this information based on other received/fetched information.

A stress heatmap can be an area- or volume-dependent description of effects of an externally caused load, e.g. by external forces and/or temperatures, which are exerted to a mechanical object. A stress heatmap can also be a description of internal effects, like chemical effects and/or physical effects that occur inside a mechanical object, e.g. a delayed ettringite formation (DEF) also known as internal sulfate attack (ISA) within concrete. A stress heatmap can describe stress, strain, deformations, an internal energy of a mechanical object, and/or other constitutive relation that effects the mechanical object.

A stress heatmap can be any kind of description of a mechanical object that results from a computer-based simulation with a load scenario or from a measurement in a load scenario. A stress heatmap can be a visual representation to depict a distribution of stress across a mechanical object due to a mechanical load. A stress heatmap can identify a layer of the mechanical object, e.g. a top layer, a bottom layer, and/or an intermediate layer. A stress heatmap can identify a plane layer and/or a curved layer. In general, a layer for a stress heatmap can have any form. It can employ a color-coded system to indicate different levels of stress. This is done to transform complex stress data into an easily understandable visual format. However, other representations of stress-distributions on a mechanical object due to a load are also comprised in the sense of a load scenario in this disclosure. Stress heatmaps can be generated using computational techniques like finite element analysis (FEA). In this process, the structure is divided into a mesh of elements, and the stress on each element is calculated.

A stress heatmap may also indicate at which point a material begins to deform permanently, with deformations below this point being reversible (elastic deformation) and those above being permanent (plastic deformation). A stress heatmap may also indicate stress concentration, which can be an area on or in the mechanical object where stress is concentrated, often due to abrupt shape changes or a potential presence of flaws. A stress heatmap may also indicate fatigue, which is a weakening of a material caused by repeatedly applied loads.

A mesh can include any pattern that can be used to arrange one or more support structures within, on, or across a mechanical object. A mesh for a mechanical object can be a digital representation used in computer-aided design (CAD) and engineering simulations, like Finite Element Analysis (FEA). A mesh can refer to a network of discrete elements (e.g. triangles or quadrilaterals) that collectively approximate a plurality of support structures. Creating a mesh may comprise dividing a computer-based model of a mechanical object into these smaller, simpler elements. Each element in the mesh can defined by nodes, corner points, and edges (the lines connecting the nodes). A mesh can be related to a distribution of a parameter of support structures. For example, a mesh can act as a scaffold that maps out support structures geometry. Additionally or alternatively, a mesh can be related to a length or a thickness of uniformly distributed ribs. A mesh can have an irregular density or is irregular in any other property. One or more irregularities of a mesh may depend on one or more load scenarios.

A support structure can be any kind of structure for a mechanical object that helps the mechanical object to endure one or more load scenarios. A support structure for a mechanical object can be an element that provides stability, strength, and/or reinforcement, ensuring the object's capability in order to endure one or more load scenarios. Support structures can function to withstand vibrations, loads, and maintain alignment. Support structures may comprise internal or external reinforcements like ribs, gussets, or struts. Support structures may also comprise different materials than a rest of the mechanical object. Additionally, protective housings and enclosures can act as support structures, safeguarding mechanical components from environmental factors and external forces. A design of a support structure may be tailored to meet specific requirements, considering factors like weight, size, operating conditions, and the forces it will encounter, aiming for effective operation, safety, and longevity.

Support structures can be generated based on a generated mesh. For example, the support structures can be ribs that are formed on the edges of the mesh. Additionally or alternatively, the mesh can modulate a parameter other than a density of the mesh. For example, the support structures can be uniformly distributed on or in a mechanical object and the mesh density modulates a height of ribs, or a stiffness of the ribs, e.g. the denser the mesh, the higher or stiffer the ribs.

A design of a mechanical object can be updated incrementally or with an incremental update, e.g. by adding support structure ribs to a mechanical object's production model. Additional or alternatively, an incremental update of a design can comprise a new computation of the design for a provided mechanical object, e.g. by redesigning a robot arm with internal, mesh-based support structures instead of a solid arm structure.

A method according to the first aspect may comprise one or more steps in which the mechanical object is produced.

By computing support structures for one or more load scenarios and designing the support structures into a mechanical object, a functioning of the mechanical object, in particular under the provided load scenarios, can be improved and a weight of the mechanical object may be reduced.

An embodiment of the first aspect is related to a computer-implemented method for generating support structures for a mechanical object, wherein the load scenario includes a mechanical and/or a thermal load.

A load may be a mechanical load, which can lead to various forms of mechanical stress within a mechanical object. Stress in a mechanical object can be related to internal forces exerted by its particles when an external force is applied. Mechanical stress can comprise tensile stress. Tensile stress may occur when forces stretch a mechanical object, leading to elongation, while compressive stress is its opposite, occurring when forces compress a mechanical object, causing shortening or compression. Mechanical stress can comprise shear stress. Shear stress may occur from forces causing parts of a material to slide past each other in opposite directions. Mechanical stress can comprise volumetric stress, in particular for soft/flexible/amorphic materials, resulting from changes in volume under external pressure. Mechanical stress can comprise bending stress. Bending stress may appear in materials subject to bending forces, e.g. in beams and bridges. Mechanical stress can comprise torsional stress. Torsional stress may occur when a material is twisted.

A load may be a thermal load, which can lead to thermal stress in a mechanical object. Thermal stress may in particular occur when a thermal expansion or contraction of a material of a mechanical object is constrained, either due to external factors like attachment to another structure or internal factors such as different parts of the object having varying expansion rates. A temperature gradient, or a difference in temperature across a material, can also cause thermal stress, leading to different parts of the material expanding differently and creating stress. An impact of thermal stress on a material may also depend on its properties, such as the thermal expansion coefficient, Young's modulus (a measure of stiffness), and the yield strength. Therefore, thermal stress may be analyzed together with mechanical stress, i.e. thermal loads may be provided together with mechanical loads in a combined load scenario. If thermal stress exceeds the material's strength, it can lead to failure modes such as cracking, warping, or even complete structural failure. This can be indicated by a stress heatmap, as well.

An embodiment of the first aspect is related to a computer-implemented method for generating support structures for a mechanical object, comprising the steps:
performing a simulation based on the load scenario and based on a mechanical and/or thermal model of the object to identify the first stress heatmap; wherein the first stress heatmap is identified based on the results of the simulation.

A model for a mechanical and/or thermal simulation can be a mathematical representation of a physical system, designed to analyze and predict its behavior under various conditions. A model for a mechanical object can comprise geometrical parameters such as length, width, height. A model for a mechanical object can comprise material and/or structural properties, such as density, elastic modulus, stiffness, damping, mass, thermal expansion coefficient, conductivity, and/or specific heat capacity. A model for a mechanical object can comprise one or more boundary conditions, e.g. to define how a mechanical object interacts with its environment. A model of a mechanical object can be defined as mesh, especially in Finite Element Analysis (FEA), where the accuracy of the simulation can hinge on the size and shape of these mesh elements. Other methods, e.g. numerical methods, can also be applied to model a mesh. A model can be configured to apply one or more load conditions of one or more load scenarios. A model for a mechanical object can comprise a plurality of submodels, e.g. a mechanical model and a thermal model. A model can also be a trained model for a machine-learning-based simulation. A model can also be a metamodel, a reduced-order model, and/or digital twin.

Additionally or alternatively to a simulation, a measurement can be performed to arrive at a stress heatmap. A stress heatmap can be an integrated stress heatmap comprising simulated and measured data.

An embodiment of the first aspect is related to a computer-implemented method for generating support structures for a mechanical object, further comprising the steps:
identifying one or more additional stress heatmaps to represent stress characteristics of one or more additional layers along a cross-section of the object and/or at different points in time, based on a simulation; wherein the mesh of the support structures for the object is determined based on the first and the additional stress heatmaps.

A plurality of stress heatmaps can be arranged substantially equidistant along a cross section of a mechanical object. Thereby, stress characteristics for one or more load scenarios can be sampled at positions spaced with approximately equal distances. The distance can be provided by a human user and/or obtained automatically, e.g. based on a criterion how the stress heatmaps change from one to another.

Additionally or alternatively, a plurality of stress heatmaps can be non-equidistantly arranged, e.g. based on the changes on and/or in the mechanical object due to one or more load scenarios. For example, a distance between a plurality of stress heatmaps can be based on a gradient that quantifies a change of stress along a cross section for one or more load scenarios. Non-equidistant sample positions for stress heatmaps can also provide by a human user, i.e. obtained from a user interface.

Additionally, a plurality of stress heatmaps can come from different points of time. In particular, stress can be sampled along an object's cross section for different points of time leading to a matrix of stress heatmaps at different locations and different times. For example, sampling stress of an object at three locations along a cross sections for three time points will lead to nine stress heatmaps.

An embodiment of the first aspect is related to a computer-implemented method for generating support structures for a mechanical object, further comprising the step:-determining an integrated stress heatmap based on the first heatmap of the first layer and the additional heatmaps of the additional layers; and wherein the mesh of the support structures for the object is determined based on the integrated stress heatmap.

An integrated stress heatmap can be regarded as a virtual stress heatmap. An integrated stress heatmap can integrate all or selected information of a plurality of sampled stress heatmaps. These stress heatmaps can be sampled at a single point in time, e.g. along a cross-section. Additionally or alternatively, an integrated stress heatmaps can comprise stress heatmaps or stress information from different points of time, e.g. over a certain period. For example an integrated stress heatmap can comprise the nine sampled stress heatmaps from the example above.

Additionally an integrated stress heatmap can integrate information from other sources, e.g. can provide information to an integrated stress heatmap where a mechanical object may break due to fatigue. This knowledge can come from human experience, another simulation, and/or a measurement. An integrate stress heatmap may be generated by overlaying the first stress heatmap and the additional stress heatmaps of the additional layers. An integrated stress heatmap can have the same form as one of the layers it comprises. By integrating several stress heatmaps into one integrated heatmap, all information from the different stress heatmaps (or the corresponding layers) can be integrated into a two-dimensional, albeit possibly curved, integrated heatmap.

An integrated/virtual heatmap can be unfolded, expanded and/or stretched in relation to the stress heatmaps that it comprises. This can be done in particular to match stress heatmaps from different parts of the mechanical model, which may not be congruent and differ in their forms.

An embodiment of the first aspect is related to a computer-implemented method for generating support structures for a mechanical object, wherein the mesh includes zones of different properties, e.g. densities, related to a pre-defined mechanical and/or thermal stress range.

A mesh can be an irregular mesh. An irregular mesh can comprise one or more irregularities, i.e. non linearities. An irregularity can be related to a density of a mesh, e.g. in zones where mechanical stress has been identified to be large, a mesh of support structures can be denser or less dense than in less loaded zones. Additionally or alternatively, a mesh irregularity may be related to a height of support structures, if the support structures are formed as ribs on an inside and/or outside a mechanical object. Additionally or alternatively, an irregularity may be related to a material of support structures. An irregularity can also be related to a mechanical property of a mesh, e.g. in more loaded zones, a stiffness or density of support structures (e.g. ribs) may be larger than in less loaded areas. An irregularity can also be related to a geometrical property of a mesh, e.g. in order to robustify a mechanical object against stresses from different directions, a mesh can be generated to arrange ribs in different directions along a surface of the mechanical object or within the mechanical object. An irregularity can be a smooth irregularity, wherein a property of the mesh changes continuously. Additionally or alternatively, an irregularity can be a discrete irregularity, wherein a property of a mesh changes abruptly.

Additionally or alternatively, a mesh can have a plurality of zones with different properties. Some or all of these zones may be non-overlapping zones. For example, a first zone of a mesh of support structures can have a density (e.g. maximal distance of two edges) of 5 mm, another zone can have a size 10 mm, a further zone again a size 5 mm.

An embodiment of the first aspect is related to a computer-implemented method for generating support structures for a mechanical object, wherein the pre-defined mechanical and/or thermal stress ranges are received from a user interface.

Based on the pre-defined mechanical and/or thermal stress ranges different zones can be identified on one or more stress heatmaps and/or on an integrated stress heatmap. Based on the different zones an irregular mesh for support structures can be generated. By receiving this information from a user, experience-based knowledge, a result from another simulation, and/or a measurement can be incorporated.

An embodiment of the first aspect is related to a computer-implemented method for generating support structures for a mechanical object, further comprising the step:
obtaining different meshes of support structures for the mechanical object;
obtaining a selected mesh from a user interface;
updating the design of the mechanical object with the selected mesh of support structures.

Different meshes can be obtained by an automatic generation of the different meshes that serve as candidate support structure meshes. This can in particular be done if different support structure meshes can solve a problem provided, e.g., by a given load scenario and given boundary conditions. Then a plurality of support structure meshes, each with parameters, can be provided and the mechanical object can be displayed to a user with these different candidate support structure meshes. For example, different meshes of ribs lead to a similar result for an enforcement of a mechanical object with respect to a load scenario. Then a user can select between the different meshes, based on subjective criteria, e.g. esthetical criteria. A user can provide different mesh parameter types that can be used to generated different meshes in advance. For example, a user can provide that a mesh can vary in density, rib material, rib height, rib thickness, rib form, etc.

An embodiment of the first aspect is related to a computer-implemented method for generating support structures for a mechanical object, wherein the mesh of the support structures includes a Voronoi mesh.

A mesh can be formed based on triangular structures, such as a Delaunay Triangulation. In a triangular mesh points in a plane are connected to triangles. The unique property of a Delaunay triangulation is that no point lies inside the circumcircle of any triangle. This can result in triangles that are close to equilateral as possible, i.e. long, thin triangles are avoided.

A mesh can also be based on other structures or principles. As introduced with the embodiment above, a mesh can be a Voronoi mesh. A Voronoi mesh divides a plane into regions based on a set of seed points. Each region contains all the points that are closer to one seed point than to any other. The edges of these regions are equidistant from the nearest two seed points. In an embodiment, a mesh can be generated as a triangulation, in particular a Delaunay

Triangulation, at first. Then the mesh can be transformed to a Voronoi map, and the support structures can be generated based on the Voronoi map. The points for the Voronoi map can be chosen as the center points of the triangles of triangular mesh (i.e. The intersection of the three bisectors of a triangle).

An embodiment of the first aspect is related to a computer-implemented method for generating support structures for a mechanical object, further comprising the step:
obtaining a desired mechanical and/or thermal characteristics of the mechanical object; wherein the mesh of the support structures of the mechanical object is based on the desired characteristics.

Desired characteristics can include, e.g., stiffness, damping, a thermal conductivity in a given area of the object, or a thermal conductivity direction in a given area/part of the object. The desired characteristics can be regarded as a load scenario. Additionally or alternatively, the desired characteristics can be provided and considered parallel to a load scenario.

An embodiment of the first aspect is related to a computer-implemented method for generating support structures for a mechanical object, wherein the desired mechanical characteristics includes a breaking point.

A deliberate breaking point in a mechanical object can be an intentionally engineered area or component that is designed to fail under specific conditions to protect the rest of the mechanical object. A breaking point can refer to a point, a line, or an area. A breaking point can be a weaker section configured to break or deform at a lower stress level compared to the rest of the mechanical object. This can be in particular designed by providing a less dense mesh at a breaking point. Additionally or alternatively, at a breaking point a different material can be used for the mesh of the mechanical object. Hence, a breaking point can relate to a discrete change in a mesh parameter.

An embodiment of the first aspect is related to a computer-implemented method for generating support structures for a mechanical object, wherein the support structures are provided for inside of the object.

This can be done e.g. for structures such as beams, arms, and/or cantilevers. For example, an arm for a robot can comprise inner support structure. Since a robot may be designed only for single a specific task, the support structures need only to fulfill this load scenario. The remaining degrees of freedom in the design of the robot can be used to improve performance and/or reduce costs. In another example, the housing of a windmill generator can be generated based on support structures that are designed based on their mesh such that the housing is robust against forces generated by wind and wind gusts. Furthermore, the support structures can be designed (based on an appropriate mesh) such that a resonance frequency of the housing cannot be excited by the moving blades of the rotor.

An embodiment of the first aspect is related to a computer-implemented method for generating support structures for a mechanical object, wherein the support structures are provided for outside of the mechanical object and are based on extrusion of the mesh.

An extrusion of a mesh can be performed for a generation of support structures, e.g. ribs, by using the geometry of the edges of the mesh. The support structures can be formed as walls of along the edges of the mesh, or in other words, the edges are extruded to form the support structures. This can be done to form support structures at the outside of the mechanical object. In this way the volume of a mechanical object can be increased. Additionally or alternatively, support structures can also be provided in the inside of the mechanical object, e.g. replacing at least parts of the original structures of a mechanical object. In this way a volume of a mechanical object may be kept the same or may even be decreased. For example, a robot arm that was initially designed with as a solid beam may be updated by struts, wherein the struts are mesh-based support structures.

An embodiment of the first aspect is related to a computer-implemented method for generating support structures for a mechanical object, wherein the mesh of the support structures is determined based on an additional side condition, in particular a side condition provided by a manufacturing machine or method.

Side conditions can be mechanical or thermal side conditions that are not included in a load scenario, e.g. side conditions can comprise constraints that stem from a manufacturing method of the support structures and/or from safety requirements. For example, if it would be too costly for a machine to manufacture support structures in a certain area of a mechanical object, a side condition can specify that this area should be manufactured without support structures. Additionally or alternatively, side conditions can be non-mechanical parameters that do not occur in a load scenario. For example, a side condition can lead to a preferred esthetic form of a support structure mesh.

A second aspect of the present disclosure is related to a device for manufacturing an object with support structures, configured to:
obtain one or more load scenarios;
identify a first stress heatmap to represent stress characteristics of a first layer along a cross section of a mechanical object based on the one or more load scenarios;
determine a mesh of support structures for the object based on the stress heatmap;
update a design of the mechanical object with the support structures according to the mesh for manufacturing the mechanical object.

A device for manufacturing an object with support structures can execute a method according to the first aspect of this disclosure.

A third aspect of the present disclosure is related to a mechanical object with support structures, manufactured with a method and/or with a device according to one of the preceding claims.

### BRIEF DESCRIPTION OF THE DRAWINGS

Further advantages and features result from the following embodiments, some of which refer to the figures. The figures do not always show the embodiments to scale. The dimensions of the various features may be enlarged or reduced, in particular for clarity of description. For this purpose the figures are at least partially schematized.

FIG. 1 illustrates a method for generating support structures for a mechanical object according to an embodiment of the present disclosure.

FIG. 2 illustrates a method for generating support structures for a mechanical object according to an embodiment of the present disclosure.

FIG. 3 illustrates a refinement of a mesh based on a part of a stress heatmap and mesh-based support structures for a mechanical object according to an embodiment of the present disclosure.

FIG. 4 illustrates a robot arm with mesh-based support structures according to an embodiment of this disclosure.

FIG. 5 illustrates a method for generating support structures according to an embodiment of this disclosure.

FIG. 6 illustrates a digital information processing system according to an embodiment of this disclosure.

FIGS. 7A-7C illustrate a digital information processing system according to an embodiment of this disclosure.

In the following description reference is made to the accompanying figures which form part of the disclosure, and which illustrate specific aspects in which the present disclosure can be understood. Identical reference signs refer to identical or at least functionally or structurally similar features.

In general, a disclosure of a described method also applies to a corresponding device (or apparatus) for carrying out the method or a corresponding system comprising one or more devices and vice versa. For example, if a specific method step is described, a corresponding device may include a feature to perform the described method step, even if that feature is not explicitly described or represented in the figure. On the other hand, if, for example, a specific device is described on the basis of functional units, a corresponding method may include one or more steps to perform the described functionality, even if such steps are not explicitly described or represented in the figures. Similarly, a system can be provided with corresponding device features or with features to perform a particular method step. The features of the various exemplary aspects and embodiments described above or below may be combined unless expressly stated otherwise.

### DETAILED DESCRIPTION

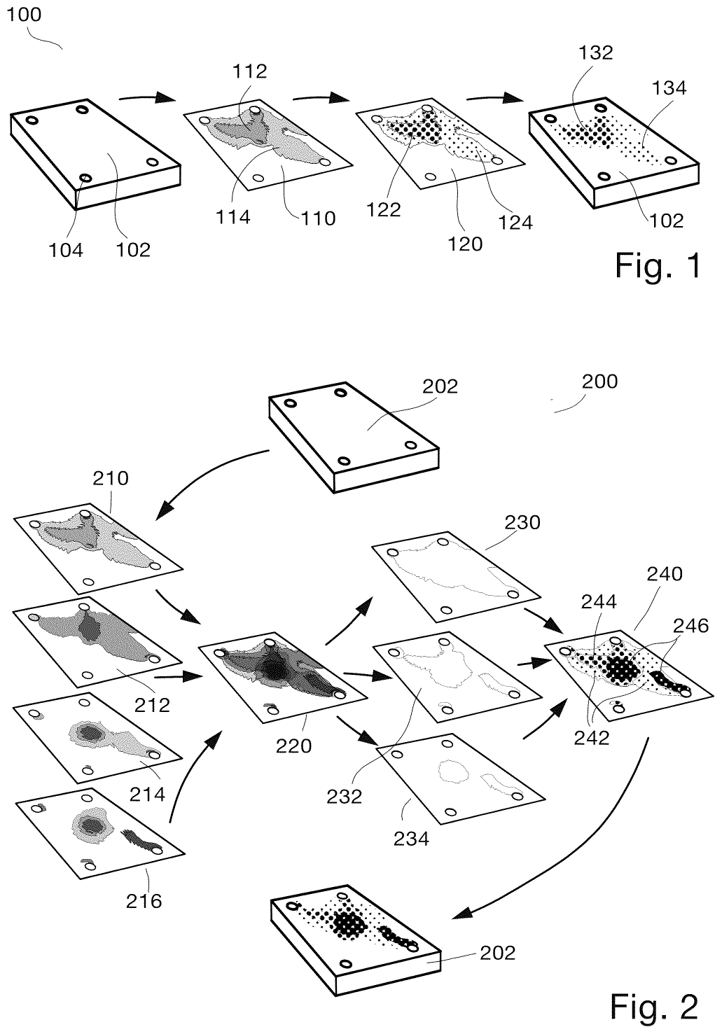

FIG. 1 illustrates a method for generating support structures 100 for a mechanical object according to an embodiment of the present disclosure. The mechanical object 102 is a rectangular plate with four mounting holes 104 by which it is mounted in an environment, e.g. as a cover of a machine (not depicted). In a first step, a load scenario is obtained for the plate 102. The load scenario represents a mechanical load, i.e. mechanical stresses, that the plate experiences during its usage.

In a second step, based on the load scenario, a stress heatmap 110 is identified for the plate 102. The stress heatmap represents areas of the mechanical object that are subject to forces of different magnitude ranges. Areas where large forces (i.e. forces that exceed a pre-defined threshold) are exerted to the plate 102 are indicated by the dark grey area 112. Areas where medium forces are exerted to the plate 102 are indicated by the light grey area 114. The white area of the plate is the area where the plate does not experience significant forces during its use. The stress heatmap can be obtained by a computer-based simulation and/or by a measurement.

In a third step, a mesh of support structures 120 is computed based on the stress heatmap 110. The mesh can vary in various pre-defined parameters, such as density, mesh-type, and/or form of support structures. The mesh area 122 is computed for the area of the mechanical object 102 that experiences the largest forces. The mesh area 124 is computed for the area of the plate 102 that experiences medium forces. For the area of low forces (the white area) it is computed that no mesh is necessary.

In a fourth step, a design of the rectangular plate 102 is updated with the computed mesh-based support structures 120. Therefore, the mesh in the dense mesh area 122 is extruded to ribs 132 arranged with small distances between each other. The mesh in the sparse density mesh area 122 is extruded to ribs 134 that are arranged with larger distances between each other. This enforces the plate sufficiently to endure its functioning under the specified load structure.

In a fifth step, the mechanical object 102 with the support structures 132, 134 is manufactured.

FIG. 2 illustrates a method 200 for generating support structures for a mechanical object according to an embodiment of the present disclosure. The mechanical object 202 is a rectangular plate similar to the mechanical object 102, which shall be used as a cover of a machine (not depicted). In a first step, a plurality of load scenarios are obtained for the plate 202. The load scenarios represent mechanical loads and thermal loads that the plate 202 experiences during its usage.

In a second step, based on the multiple load scenarios, four stress heatmaps are obtained along a cross-section of the plate 202. One stress heatmap 210 is obtained for mechanical and/or thermal stresses on the top of the plate 202. One stress heatmap 212 is obtained for mechanical and/or thermal stresses in an upper center of the plate 202. One stress heatmap 214 is obtained for mechanical and/or thermal stresses in a lower center of the plate 202. One stress heatmap 216 is obtained for mechanical and/or thermal stresses on the bottom of the plate 202. The heatmaps are obtained by simulation, based e.g. on a mathematical/physical model, a trained metamodel, a reduce order model, and/or measurement.

In a third step, the four different stress heatmaps 210-216 are integrated into a virtual stress heatmap 220. This is done by superimposing the four single heatmaps 210-216. Furthermore, the integrated stress heatmap is post-processed in order to simplify the computation of a mesh of support structures. For example, the areas of the different forces are smoothened to simplify computation of a respective mesh. Additionally or alternatively, the areas of the different forces can be increased, or a pre-defined margin can be added, in order to account for forces that have not been sampled by the four different stress heatmaps 210-216.

In a fourth step, based on the integrated stress heatmap 220, an irregular mesh is computed in order to take into account the position-dependent loads. Therefore, three force ranges are determined. A first force area 230 is comprised in a first refinement layer of the mesh in which forces are over a first threshold. A second force area 232 is comprised in a second refinement layer of the mesh in which forces are over a second threshold, which is larger than the first threshold. And a third force area 234 is comprised in a third refinement layer of the mesh in which forces are over a third threshold, which is larger than the first and the second threshold.

In a fifth step, based on the force areas 230-234, an irregular mesh 240 of support structures can be computed that meets the position-depended load characteristics. The irregular mesh 240 comprises a sparse mesh 242 for support structures that will only experience minor forces. This mesh is continuously transformed to a medium-dense mesh 244 for support structures for medium forces. The continuous transformation can be performed, e.g. by a position-based weighting function. The medium-dense mesh 244 is then continuously transformed to a dense mesh 246, for two rather small parts that experience high forces.

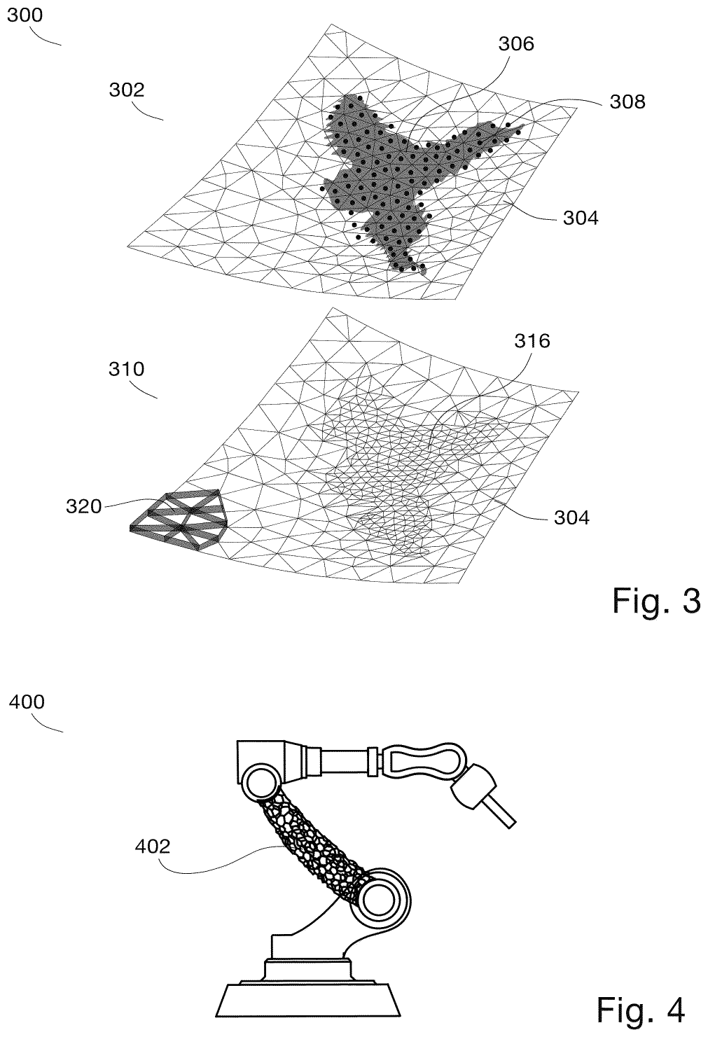

FIG. 3 illustrates a refinement of a mesh 300 based on a part of a stress heatmap (a medium stress range) and mesh-based external support structures for a mechanical object according to an embodiment of the present disclosure. In a first step, an initial mesh structure 302 is provided for a layer of a mechanical object, e.g. a top layer. The initial mesh structure comprises a sparse mesh 304. The sparse mesh 304 may come from a prior refinement which can in principle also work as described here.

Over the sparse mesh an area 306 of medium high stress is superimposed. The medium-high stresses may comprise all stresses that are above a certain stress threshold. The medium stress area may come from a stress heatmap, which was simulated and/or measured in a prior step. The triangles of the sparse mesh 304 which are at least partially covered by the medium stress area 306 are indicated by black dots 308. These dots are used for a mesh refinement in the next step.

Based on the identified triangles of the sparse mesh 304 that are covered by the area of specified medium-range stress, a mesh refinement is conducted and a refined mesh structure 310 is obtained. This is done by dividing all triangles covered by the stress area 306, i.e. which comprise a dot 308, into two triangles. This causes the part of the mesh which is covered by the stress field 306 to become denser 316. In other words the triangles of the mesh covered by the stress area 306 are smaller. As a result, the mesh of the refined mesh structure 310 comprises a sparse submesh 304 and a dense submesh 316.

If larger stress ranges are defined, the refinement can be repeated. This would lead to a further mesh that is denser than the mesh 316 and lies within the area of the mesh 316. The final mesh can be extruded to obtain support structures 320. This is shown only for a small part of the mesh structure 310. If the depicted area of the mesh structure 310 is a top area of a mechanical object, the support structure would be an external part of the mechanical object.

FIG. 4 illustrates a robot 400 with mesh-based internal support structures 402 for an arm of the robot, according to an embodiment of the invention.

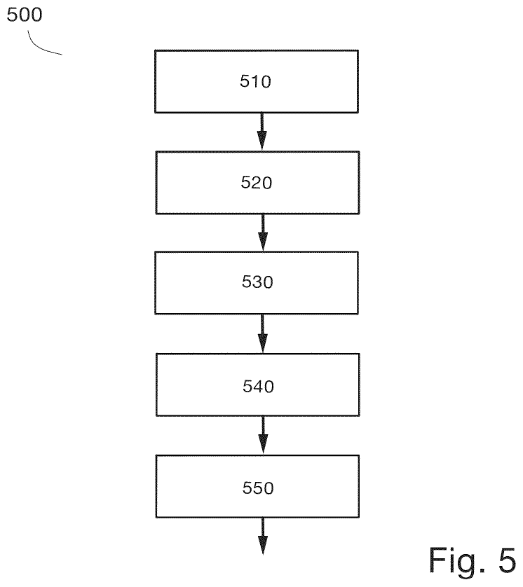

FIG. 5 illustrates a method for generating ribs on a mechanical object according to an embodiment of this disclosure. The method 500 can be used to design ribs on an adaptive mesh that considers multiple stress states coming from different simulated scenarios and thickness sections of a plastic part as a mechanical object.

In a first step 510 in virtual space, stresses from all available simulated scenarios and sections throughout the thickness of the plastic part are extracted from real space and mapped to a virtual space. In this embodiment, the virtual space is a 2D space whose boundaries are defined by the unfolded/expanded/stretched out real geometry or geometries. In virtual space, the thickness dimension is lost, and all results are mapped to a single layer, allowing a single virtual/integrated heatmap to be composed that shows the maximum values from all results.

In a second step 520, once the heatmap is composed, the refinement areas can be exported back to real space. In this embodiment, the refinement areas are based on a user-defined threshold and number of refinement levels. This means that the algorithm in a loop for each refinement level selects areas of corresponding stresses in the virtual space and once selected for the current refinement level, it can be exported back to real space and mapped to a user-defined surface. Such a refinement area in real space may only provide information about where to refine the rib mesh, the stress range for which it was exported is no longer needed and can therefore be discarded.

In a third step 530, after exporting all refinement areas from the previous step, the generation of the rib mesh can begin. At the beginning, the user-selected surface on which the ribs are to be generated is meshed using an initial Delaunay triangulation. The triangles of the mesh can be sized according to, e.g. the user's input. Next, a loop is run over all exported refinement areas. In each iteration, the current refinement area is mapped onto the current mesh. Triangles from the current mesh are then selected if they are near or within the refinement area. The distance to which triangles are selected from the refinement area can be specified, for example, based on user inputs (artificially extended selection). Once the triangles are selected, they are refined using a user-defined factor or re-meshed to match the user-defined size. The loop continues to the next iteration.

In a fourth step 540, after the loop is completed, the refined Delaunay triangulation is converted to Voronoi tessellation.

In a fifth step 550, the Voronoi tessellation is then used to extrude the ribs, i.e. each edge of the Voronoi tessellation represents the longitudinal axis of a rib. The actual size and shape of the ribs are free parameters. The disclosed mechanism can be performed as part of post-processing of existing design/simulation software (Mechanical, LS-DYNA, Discovery) that would eventually trigger a subsequent re-evaluation of the results with the generated rib mesh.

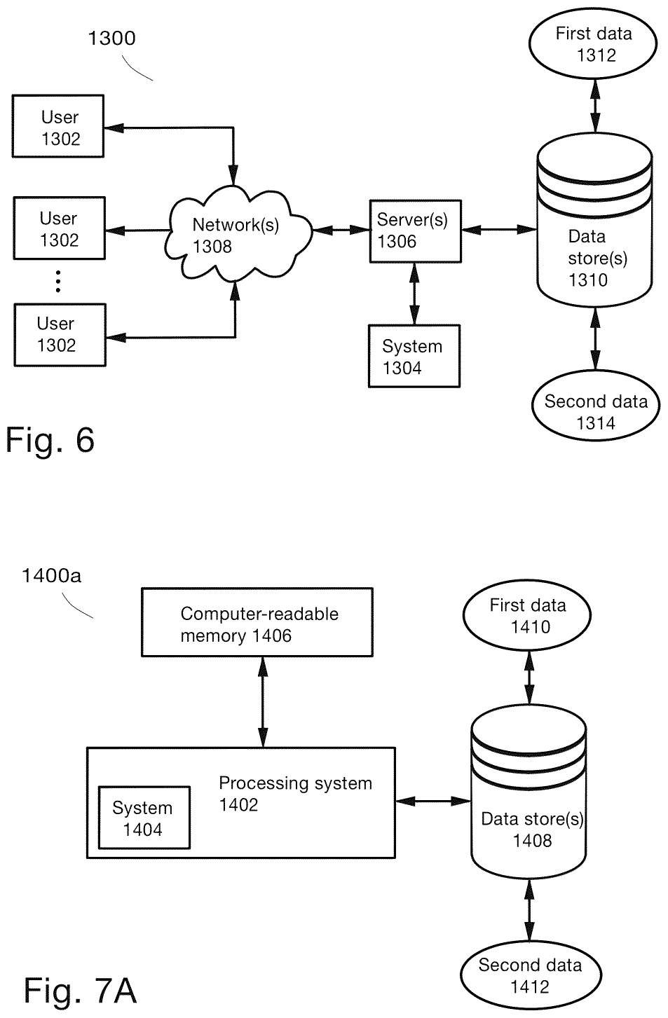

FIG. 6 depicts a computer-implemented environment 1300 wherein users 1302 can interact with a system 1304 hosted on one or more servers 1306 through a network 1308. The system 1304 contains software operations or routines. The users 1302 can interact with the system 1304 through a number of ways, such as over one or more networks 1308. One or more servers 1306 accessible through the network(s) 1308 can host system 1304. The processing system 1304 has access to a non-transitory computer-readable memory in addition to one or more data stores 1310. The one or more data stores 1310 may contain first data 1312 as well as second data 1314. It should be understood that the system 1304 could also be provided on a stand-alone computer for access by a user.

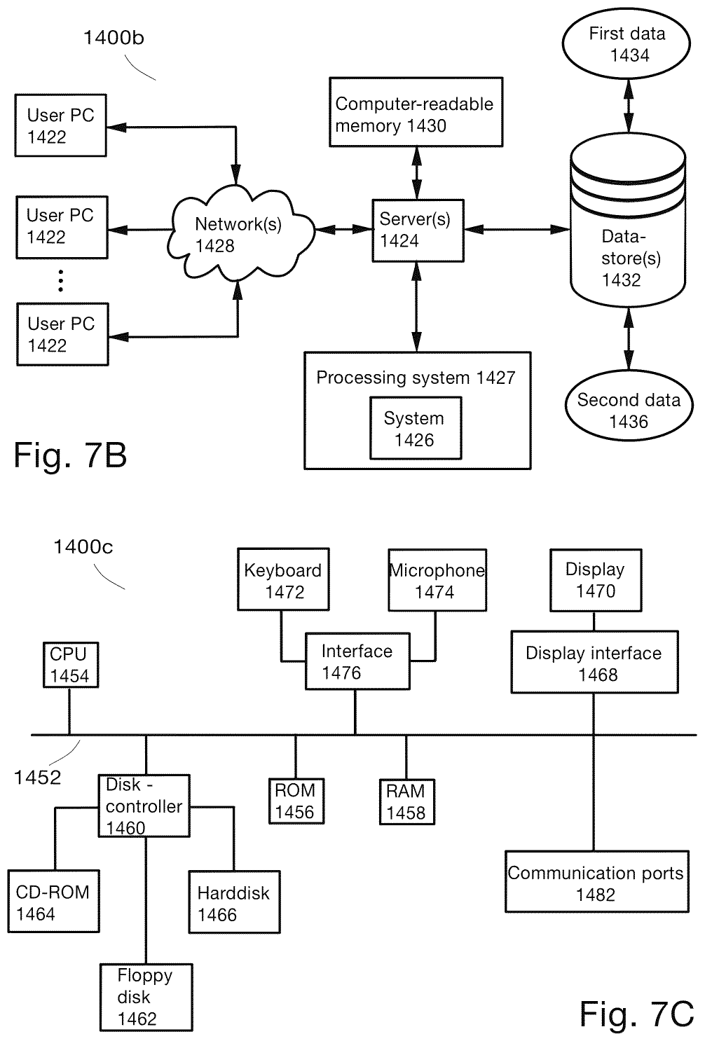

FIGS. 7A, 7B and 7C depict example systems for use in implementing a system. For example, FIG. 7A depicts an exemplary system 1400a that includes a standalone computer architecture where a processing system 1402 (e.g., one or more computer processors) includes a system 1404 being executed on it. The processing system 1402 has access to a non-transitory computer-readable memory 1406 in addition to one or more data stores 1408. The one or more data stores 1408 may contain first data 1410 as well as second data 1412.

FIG. 7B depicts a system 1400b that includes a client server architecture. One or more user PCs 1422 can access one or more servers 1424 running a system 1426 on a processing system 1427 via one or more networks 1428. The one or more servers 1424 may access a non-transitory computer readable memory 1430 as well as one or more data stores 1432. The one or more data stores 1432 may contain first data 1434 as well as second data 1436.

FIG. 7B shows a block diagram of exemplary hardware for a standalone computer architecture 1400c, such as the architecture depicted in FIG. 5A, that may be used to contain and/or implement the program instructions of system embodiments of the present disclosure. A bus 1452 may serve as the information highway interconnecting the other illustrated components of the hardware. A processing system 1454 labeled CPU (central processing unit) (e.g., one or more computer processors), may perform calculations and logic operations required to execute a program. A non-transitory computer-readable storage medium, such as read only memory (ROM) 1456 and random-access memory (RAM) 1458, may be in communication with the processing system 1454 and may contain one or more programming instructions. Optionally, program instructions may be stored on a non-transitory computer-readable storage medium such as a magnetic disk, optical disk, recordable memory device, flash memory, or other physical storage medium. Computer instructions may also be communicated via a communications signal, or a modulated carrier wave, e.g., such that the instructions may then be stored on a non-transitory computer-readable storage medium.

A disk controller 1460 boundary layers one or more optional disk drives to the system bus 1452. These disk drives may be external or internal floppy disk drives such as 1462, external or internal CD-ROM, CD-R, CD-RW, or DVD drives such as 1464, or external or internal hard drives 1466. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1460, the ROM 1456 and/or the RAM 1458. Preferably, the processor 1454 may access each component as required.

A display boundary layer 1468 may permit information from the bus 1456 to be displayed on a display 1470 in audio, graphic, or alphanumeric format. Communication with external devices may optionally occur using various communication ports 1482.

In addition to the standard computer-type components, the hardware may also include data input devices, such as a keyboard 1472, or other input device 1474, such as a microphone, remote control, pointer, mouse, touchscreen and/or joystick. These input devices can be coupled to bus 1452 via boundary layer 1476.

In the following further examples and embodiments of these examples are provided:

A first example of this disclosure relates to a computer-implemented method for generating support structures for a mechanical object, comprising the steps:
obtaining one or more load scenarios;
identifying a first stress heatmap 110 to represent stress characteristics of a first layer of a mechanical object based 102 on the one or more load scenarios;
determining an mesh of support structures 120 for the object based on the stress heatmap;
updating a design of the mechanical object with the support structures 132, 134 according to the mesh for manufacturing the mechanical object.

An embodiment of the preceding example relates to a method, wherein the load scenario includes a mechanical and/or a thermal load.

An embodiment of the preceding example relates to a method, further comprising:
performing a simulation based on the load scenario and based on a mechanical and/or thermal model of the object to identify the first stress heatmap 110; and wherein the first stress heatmap is identified based on the results of the simulation.

An embodiment of the preceding example relates to a method, further comprising:
identifying one or more additional stress heatmaps 212-216 to represent stress characteristics of one or more additional layers along a cross-section of the object 202 and/or at different points in time, based on a simulation; wherein the mesh of the support structures for the object is determined based on the first and the additional stress heatmaps 210-216.

An alternative of the preceding embodiment relates to a method, further comprising:
determining an integrated stress heatmap 220 based on the first heatmap 210 of the first layer and the additional heatmaps 212-216 of the additional layers; and
   wherein the mesh of the support structures for the object is determined based on the integrated stress heatmap.

An embodiment of the preceding example relates to a method, wherein the mesh 240 includes zones of different properties, e.g. densities, related to a pre-defined mechanical and/or thermal stress range 230-234.

An alternative of the preceding embodiment relates to a method, wherein the pre-defined mechanical and/or thermal stress ranges 230-234 are received from a user interface.

An embodiment of the preceding example relates to a method, further comprising:
obtaining different meshes 240 of support structures for the mechanical object 102;
obtaining a selected mesh 240 from a user interface;
updating the design of the mechanical object with the selected mesh of support structures 240.

An embodiment of the preceding example relates to a method, wherein the mesh 240 of the support structures includes a Voronoi mesh.

An embodiment of the preceding example relates to a method, further comprising:
obtaining desired characteristics of the mechanical object 202, the desired characteristics including mechanical and/or thermal characteristics;
wherein the mesh of the support structures 240 of the mechanical object is based on the desired characteristics.

An alternative of the preceding embodiment relates to a method, wherein the desired characteristics includes a breaking point.

An embodiment of the preceding example relates to a method, wherein the support structures 402 are provided for inside of the object.

An embodiment of the preceding example relates to a method, wherein the support structures are provided for outside 320 of the mechanical object 102 and are based on extrusion of the mesh.

An embodiment of the preceding example relates to a method, wherein the mesh 204 for the support structures are determined based on an additional side condition, in particular a side condition provided by a manufacturing machine or method.

An second example of this disclosure relates to a device for manufacturing an object with support structures, configured to:
obtain one or more load scenarios;
identify a first stress heatmap 110 to represent stress characteristics of a first layer along a cross section of a mechanical object 102 based on the one or more load scenarios;
determine a mesh of support structures 120 for the object based on the stress heatmap; and
update a design of the mechanical object with the support structures 132, 134 according to the mesh for manufacturing the mechanical object.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

### LIST OF REFERENCE SIGNS

100 method for generating mesh based support structures
102 mechanical object
104 mounting holes
110 stress heatmap
112 area of large forces
114 area of medium forces
120 mesh of support structures
122 dense mesh area
124 dense mesh area
132 dense rib mesh
134 sparse rib mesh
200 method for generating mesh based support structures
202 mechanical object
210 stress heatmap top
212 stress heatmap top
214 stress heatmap top
216 stress heatmap top
220 integrated stress heatmap
230 mesh refinement level 1
232 mesh refinement level 2
234 mesh refinement level 3
240 mesh based support structures
242 sparse mesh
244 medium-dense mesh
246 dense mesh
300 mesh refinement and extrusion
302 initial mesh structure
304 sparse mesh
306 area of high stress
308 indication dots
310 refined mesh structure
316 dense mesh
320 external support structures
400 robot
402 internal support structures
500 method for rib design
510 composition of the spatial stress heatmap
520 refinement of mesh areas
530 heatmap driven rib mesh generation
540 mesh type transformation
550 rib extrusion

What is claimed is:

1. A computer-implemented method comprising:
receiving a model representing a mechanical object including a plurality of layers through a thickness dimension;
simulating stress characteristics of the layers based on the model of the mechanical object under one or more load conditions;
generating a stress heatmap as a combination of the stress characteristics simulated for the plurality of layers, the stress heatmap represented as a surface in a 2D space without the thickness dimension;
determining a mesh of a support structure for the mechanical object based on the stress heatmap; and
updating a design of the mechanical object with the support structure based on the mesh for manufacturing the mechanical object based on the updated design.

2. The method of claim 1, wherein the one or more load conditions include a mechanical and/or a thermal load.

3. The method of claim 1, wherein the model includes a mechanical model and a thermal model for the mechanical object.

4. The method of claim 1, wherein the plurality of layers include a first layer and a second layer, wherein the stress characteristics of the layers include a first heatmap of the first layer and a second heatmap of the second layer, and wherein the combination is based on superimposing the first heatmap and the second heatmap.

5. The method of claim 4, wherein the first heatmap and the second heatmap representing stress levels over the surface in the 2D space, and wherein the superimposing is based on a selection of stress levels of the first heatmap or stress levels of the second heatmap.

6. The method of claim 1, wherein the stress heat map includes a plurality of refinement areas, each refinement area associated with a respective density characteristic of the support structure.

7. The method of claim 6, wherein the determining the mesh comprises:
identifying the refinement areas based on ranges of stress levels in the stress heatmap.

8. The method of claim 7, wherein each refinement area corresponds to a separate range of stress levels in the stress heatmap.

9. The method of claim 7, further comprising:
generating an initial mesh over a surface in real space for the mechanical object;
exporting the refinement areas of the surface in the 2D space to the surface in real space;
refining the initial mesh to obtain the mesh according to the refinement areas exported to the surface in real space.

10. The method of claim 9, wherein the surface in real space is obtained according to a user input received.

11. The method of claim 9, wherein a plurality of zones of surface in real space are defined according to the refinement areas, each zone corresponding to a respective level of refinement based on the refining.

12. The method of claim 11, wherein the plurality of zones are non overlapping and wherein at least one of the zones corresponds to an overlap of two refinement areas.

13. The method of claim 9, further comprising:
extruding the mesh along the thickness dimension for the support structure including a plurality of ribs, each rib corresponding to an edge of the mesh.

14. The method of claim 1, wherein the mesh includes a Voronoi mesh.

15. A non-transitory computer-readable memory storing instructions for commanding one or more processors to:
receive a model representing a mechanical object including a plurality of layers through a thickness dimension;
simulate stress characteristics of the layers based on the model of the mechanical object under one or more load conditions;
generate a stress heatmap as a combination of the stress characteristics simulated for the plurality of layers, the stress heatmap represented as a surface in a 2D space without the thickness dimension;
determine a mesh of a support structure for the mechanical object based on the stress heatmap; and
update a design of the mechanical object with the support structure based on the mesh for manufacturing the updated design of the mechanical object.

16. A system, comprising:
a memory storing instructions;
one or more processors coupled to the memory, the one or more processors executing the instructions from the memory, the one or more processors configured to perform a method comprising:
receiving a model representing a mechanical object including a plurality of layers through a thickness dimension;
simulating stress characteristics of the layers based on the model of the mechanical object under one or more load conditions;
generating a stress heatmap as a combination of the stress characteristics simulated for the plurality of layers, the stress heatmap represented as a surface in a 2D space without the thickness dimension;
determining a mesh of a support structure for the mechanical object based on the stress heatmap; and
updating a design of the mechanical object with the support structure based on the mesh for manufacturing the updated design of the mechanical object.
